(19) United States
(12) Patent Application Publication
(10) Pub. No.: US 2019/0162585 A1
(43) Pub. Date: May 30, 2019

(54) SYSTEM FOR CAPTURING POINT OF CONSUMPTION DATA

(71) Applicant: Perfect Company, Inc., Vancouver, WA (US)

(72) Inventors: Michael Wayne Wallace, Vancouver, WA (US); Daniel Short, Camas, WA (US)

(21) Appl. No.: 15/827,653

(22) Filed: Nov. 30, 2017

(51) Int. Cl. G01G 19/414; G01G 19/415; G09B 19/00; G06F 3/048; H04L 12/28; H04W 4/00

(52) U.S. Cl. CPC G01G 19/4146; G01G 19/415; G09B 19/0092; A47J 2043/0733; H04L 12/2827; H04W 4/008; G06F 3/048

(57) ABSTRACT

This system describe herein uses a recipe application and verification information from one or more appliances to capture corroborated point of consumption (POC) data for food consumed by an individual. The recipe application may present a graphical recipe interface that includes a recipe step that a certain amount of an ingredient is to be added to a container that is on a kitchen scale. An appliance may detect a change in the mass of the container indicative of addition of the ingredient, and then provide information data associated with the addition of the ingredient to the recipe application via a wired or wireless connection. The recipe application may receive the information, and then verify that the ingredient was added to the scale. Once the addition of the ingredient has been verified, the recipe application generates and stores verified consumption data for the ingredient.

### BACKGROUND

From counting calories to ensuring appropriate nutrient intake, tracking the food consumed by a person is an important part of practicing a healthy diet. However, current systems for tracking food consumption involve individuals entering their food intake into a log on an item by item basis. Not only are current processes for logging individual consumed food items time consuming, but they are especially ill fit for people who prepare a majority of their diet from scratch. This is because it is impossible to pre-load nutrition information for homemade recipes, especially when such recipes are often determined by what an individual has available in his or her home. Such individuals are often left with a choice of individually logging each ingredient in a recipe into the system, or selecting a previously entered food item that they feel resembles the food they prepared.

Another problem with current systems for tracking food consumed by individuals is that the information that is logged by the individuals is often unreliable. This can be attributed to either individuals misjudging (or deliberately mis-entering) the quantity of food they eat, and/or that people are so turned off by the process of entering individual ingredients in a recipe that they enter in a close approximation. Thus, there is a need for a system that allows users to more easily track the food they consume, especially for individually who prepare most of their diet from scratch.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is an illustrative environment for capturing corroborated point of consumption (POC) data for food consumed by an individual.

FIG. 2 is an illustrative computing architecture of a computing device configured to capture and store corroborated POC data for food consumed by an individual.

FIG. 3 is a flow diagram of an illustrative process for generating corroborated POC data for food consumed by an individual.

FIGS. 4A and 4B are example illustrations of a user computing device and an appliance configured to capture corroborated POC data for food consumed by a user.

FIG. 5 is a flow diagram of illustrative process for generating corroborated POC data for food consumed by an individual that includes brand information.

FIG. 6 is a flow diagram of illustrative process for generating corroborated POC data for food consumed by an individual using a POC application

FIGS. 7A and 7B are example illustrations of a user computing device to capture user input for corroborating ingredients added by a user.

FIG. 8 is a flow diagram of illustrative process for generating corroborated POC data for food consumed by an individual.

### DETAILED DESCRIPTION

This disclosure is generally directed to a system for using a recipe application utilizing verification information from one or more appliances to capture corroborated point of consumption (POC) data for food consumed by an individual. An appliance may include a scale, oven, blender, mixer, refrigerator, food thermometer, or other type of tool used to store and/or prepare food. A recipe may include a set of instructions for preparing a particular food or drink item. An ingredient may include any component of a recipe, including raw ingredients (e.g., eggs, butter, oats, carrots, chicken breast, etc.), and prepared ingredients (e.g., ice cream, butter, pasta sauce, etc.).

The recipe application may be run on a computing device associated with a food preparer, such as a smartphone, tablet, personal computer, laptop, voice controlled computing device, server system, or other computing system that is able to execute and/or present one or more functionalities associated with the recipe application. In some embodiments, the computing device may be integrated into one or more of the appliances. For example, a kitchen appliance (i.e., scale, blender, oven, etc.) may include a memory and processors that enable the kitchen appliance to present a graphical recipe interface on a display.

In some embodiments, the functionalities associated with the recipe application may include a graphical recipe interface, a series of visual and/or audio signals for guiding an individual through a recipe, or a combination thereof. For example, the application may present a graphical recipe interface that includes a recipe step that a certain amount of an ingredient is to be added to a container that is on a kitchen scale. The application may also cause one or more lighting elements on the kitchen scale to be activated so as to draw the attention of the individual to the container on the kitchen scale.

An appliance may include one or more components that detect and provide information associated with recipe steps to the recipe application. The recipe steps may include one or more actions performed during preparation of a recipe (e.g., adding an ingredient to a container, turning on a blender, preheating an oven, etc.). As used herein, the term “pour event” generally refers to the recipe step of adding an ingredient to a container. In some embodiments, the appliance may be a kitchen scale configured to detect that an ingredient is being added to a container. For example, the recipe application may direct an individual to place a container on the kitchen scale, and to add a first ingredient to the container. The kitchen scale may then detect that the container has been placed onto the scale, and/or detect a change in the mass of the container. This may involve a first detection that the mass of the container is increasing, and a second detection that the mass of the container has become stable. The kitchen scale may then provide information data associated with the addition of the ingredient to the recipe application via a wired or wireless connection.

The recipe application may receive the information, and then verify that the ingredient was added to the scale. For example, the recipe application may determine that the change in mass matches an expected change in mass for the ingredient presented by the recipe application. Once the addition of the ingredient has been verified, the recipe application generates and stores consumption data for the ingredient. The consumption data may identify the ingredient, an amount added, one or more times related to the pour event (e.g., time the pour started, time the pour finished, duration of the pour event, etc.), nutritional information for the poured ingredient, a brand or other identifier associated with the ingredient, a user identifier associated with the individual preparing the recipe, an indication that the ingredient was verified by information from the appliance, etc. Once the recipe application verifies that the ingredient has been added, the recipe application may cause another ingredient for the recipe to be presented.

In some embodiments, the recipe application may also track ingredients that the individual has added without interacting with an appliance. For example, the recipe application may receive audio input from the individual that an ingredient has been added. The recipe application may then verify that the ingredient has been added based on the audio input. The recipe application may also receive an input of one or more ingredients that have been added without use of an appliance via graphical interface.

In some embodiments, the recipe application may track progression of an individual through a recipe. The recipe application may also identify that a recipe has been completed without verifying each individual ingredient of the recipe. For example, recipe application may determine that a recipe is complete by comparing the ingredients that have been verified with a threshold value. In various embodiments the threshold value may correspond to a number of verified ingredients added, a percentage of ingredients being verified, a preset value, etc. The recipe application may also determine that a recipe is complete based on input from user such as a gesture, a voice command, or information input into a physical interface or graphical user interface.

The techniques, apparatuses, and systems described herein may be implemented in a number of ways. Example implementations are provided below with reference to the following figures.

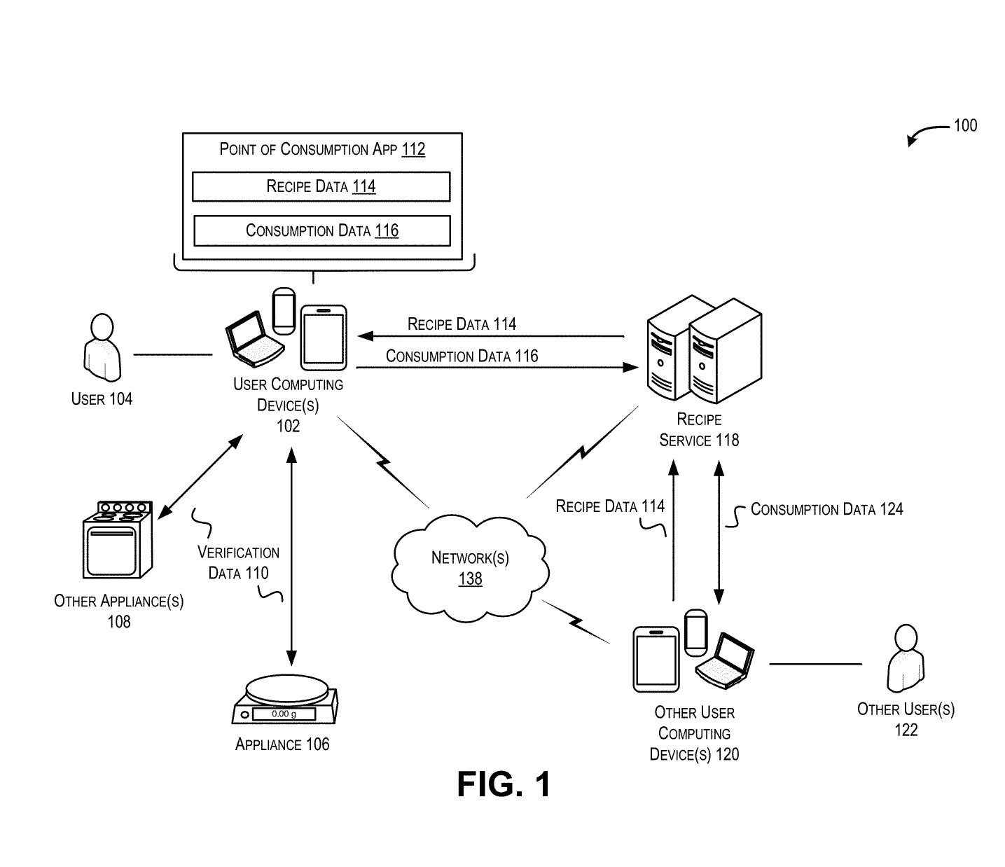

FIG. 1 is a schematic diagram of an illustrative environment 100 for capturing corroborated point of consumption (POC) data for food consumed by an individual. The environment 100 includes the user computing device 102, and user 104 associated with user computing device 102. User computing device 102 may include any type of device (e.g., a laptop computer, personal computer, voice controlled computing device a tablet device, a mobile telephone, etc.). Any such device may include one or more processor(s), computer-readable media, speakers, a display, etc.

FIG. 1 further depicts appliance 106 and other appliance 108. In various embodiments, appliance 106 and other appliance 108 may include a scale, oven, blender, mixer, refrigerator, food thermometer, or other type of tool used to store and/or prepare food. Appliance 106 may include one or more components that detect evidence of recipe actions, and provide verification data 110 associated with the recipe actions to the user computing device 102. The recipe actions may include one or more actions performed during preparation of a recipe, such as adding an ingredient to a container, turning on a blender, preheating an oven, commands input to a slow cooker, oven, or microwave oven (e.g., setting an oven to broil, setting a burner to medium, programming a microwave to cook for 2 minutes, etc.), a refrigerator or cabinet detecting that an ingredient has been removed and/or replaced with a reduced quantity (e.g., removed a bunch of 7 bananas, returned a bunch of 4 bananas), a thermometer indicating that a goal temperature has been achieved, etc.

In some embodiments, verification data 110 may correspond to sensor data from one or more sensors located within appliance 106. For example, a blender may be capable of sensing when a container is placed on the blender, or detect a change in mass that occurs when a user adds an ingredient to the blending container. The verification data 110 may also correspond to information provided by user 104 via a gesture, voice command, a physical interface, a graphical user interface, etc.

The verification data 110 may correspond to one or more sounds picked up by a microphone element associated with the user computing device 102, appliance 106, other appliance 108, or another device. The sounds may be indicative of a recipe action having been performed such as the sound of a blender running; a stand mixer mixing; a food processer chopping; a cabinet, refrigerator, oven, or microwave door being opened/closed; an alarm going off (e.g., microwave notification, timer alarm, oven notification that preheat is finished, etc.); the crack of an eggshell being broken; the hiss of a champagne bottle being opened; or similar.

In some embodiments, the user computing device 102 may include a point of consumption (POC) application 112. The POC application 112 may be an application for presenting ingredients and/or recipes to user 104 based on recipe data 114, and generating verified consumption data 116 based on verification data 110 received from appliance 106 and/or other appliance 108. For example, the functionalities may include providing a graphical recipe interface and/or series of visual and/or audio signals that guide user 104 through the process of making a recipe. For example, for individual steps of a recipe, the POC application 112 may cause user computing device 102 to present an audio instruction to perform the step. In some embodiments, when a recipe step is associated with appliance 106, POC application 112 may also cause appliance 106 to present an audio or visual signal to draw the attention of the individual to the container on the kitchen scale (e.g., the POC application 112 may cause user computing device 102 to transmit a signal to appliance 106 that an audio or video signal is to be provided).

Recipe data 114 may include one or more recipes for making individual food or drink items. Some of the recipes may be modified versions of other recipes. For example, recipe data 114 might include an original banana bread recipe submitted by a recipe service 118, a first modified version of the banana bread recipe where coconut oil is substituted for butter, and a second modified version of the banana bread recipe where walnuts are added as an additional ingredient. The recipe data 114 may also include descriptions of ingredients used in the recipes. An ingredient may include any component of a recipe, including raw ingredients (e.g., eggs, butter, oats, carrots, chicken breast, etc.), and prepared ingredients (e.g., ice cream, butter, pasta sauce, etc.). The recipe data 114 may include descriptions of the ingredients and may include nutritional information, potential substitutions for the ingredient, categorization information (i.e., “milk” may be categorized within the category “dairy”), serving size, density, etc. The recipe data 114 may describe individual ingredients generically, or it may have separate information describing corresponding branded versions of ingredients.

The POC application 112 may then receive verification data 110 corresponding to a recipe ingredient. The verification data 110 may be transmitted from appliance 106 to user computing device 102 via a wired or wireless connection. In some embodiments, where the user computing device 102 is integrated into appliance 106, the verification data may be passed between one or more sensors of the appliance and the POC application 112 via one or more internal connections. For example, where appliance 106 is a kitchen scale and user 104 adds an ingredient to a container placed upon the kitchen scale, appliance 106 may detect a change in mass of the container and transmit verification data corresponding to the change of mass to the POC application 112. In another example, for a smoothie recipe the final recipe step may be to cause a kitchen blender appliance to blend the ingredients in a container. When user 104 presses a button to cause the kitchen blender appliance to initiate blending, the kitchen blender appliance may transmit verification data 110 that indicates that the user has initiated blending.

The POC application 112 may then generate consumption data 116 based on verification data 110 received from appliance 106 and/or other appliances 108. For example, once the POC application 112 causes a recipe step to be presented to user 104, the POC application may wait for verification data 110 for the recipe step. The POC application 112 may then verify that the ingredient has been added. Verifying that the ingredient has been added may include comparing the sensor data included in the verification data 110 to expected sensor information for the ingredient. For example, the POC application 112 may know that change in mass that is to be expected when one cup of flour is added to a container, and may compare the verification data 110 to the expected mass. If the verification data 110 is within a threshold range of similarity (e.g., plus or minus a threshold percentage, a threshold numerical amount, etc.), then the POC application 112 may verify the ingredient as being added. If the verification data 110 is outside the threshold range, and is indicative of a mistake (i.e., user 104 added too much or too little of an ingredient) the POC application 112 may provide an alert to the user 104 that there has been a mistake, and/or take action to adjust the recipe (e.g., adjust the proportions of other ingredients within the recipe to compensate for the mistake). If the verification data 110 is outside the threshold range the POC application 112 may check to see if the verification data matches an alternative ingredient (i.e., a substitution, a different ingredient in the recipe, etc.), and/or prompt user 104 to add a new ingredient.

The POC application 112 may then generate consumption data 116 for the verified ingredient. The consumption data 116 may identify the ingredient, an amount added, one or more times related to the pour event (e.g., time the pour started, time the pour finished, duration of the pour event, etc.), nutritional information for the poured ingredient, a brand or other identifier associated with the ingredient, a user identifier associated with the individual preparing the recipe, an indication that the ingredient was verified by information from the appliance, etc. The consumption data 116 may correspond to the actual amount indicated in the verification data. For example, if the recipe calls for 33 g of butter to be added, but the verification data indicates that 35.7 g of butter was added to a recipe, the POC application 112 may generate consumption information for 35.7 g of butter. Once the recipe application verifies that the ingredient has been added, the recipe application may cause another ingredient for the recipe to be presented.

In some embodiments, the POC application 112 may also track ingredients that the individual has added without interacting with an appliance 106. For example, the POC application 112 may receive audio input from the individual that an ingredient has been added. The recipe application may then verify that the ingredient has been added based on the audio input. The POC application 112 may also receive an input of one or more ingredients that have been added without use of an appliance 106 via graphical interface.

The POC application 112 may also identify that a recipe has been completed without verifying each individual ingredient of the recipe. For example, POC application 112 may determine that a recipe is complete when a threshold amount of the recipe is completed. In various embodiments the threshold amount may correspond to a number of verified ingredients added, a percentage of ingredients being verified, a preset value, etc. The POC application 112 may also determine that a recipe is complete based on input from user 104 (e.g., via a gesture, voice command, a physical interface, a graphical user interface, etc.) or based on other verification data 110. For example, where the final step of a cookie recipe is to bake the cookies, the POC application 112 may determine that all ingredients have been added when an oven appliance sends verification data 110 that the oven has been set to preheat to the correct temperature. The POC application 112 may then verify that all ingredients have been added, and generate consumption data 116 for all of the remaining unverified ingredients in the cookie recipe. Alternatively or in addition, in response to the oven being preheated, the POC application 112 may prompt user 114 to indicate (via a gesture, voice command, a physical interface, a graphical user interface, etc.) what additional unverified ingredients have been added.

FIG. 1 further depicts environment 100 including recipe service 118, and other user computing device(s) 120 associated with other users 122. Recipe service 118 may be any entity, server(s), platform, etc. Recipe service 118 may store recipe data corresponding to one or more recipes and consumer consumption data. In some embodiments, recipe service 118 may be associated with an electronic recipe marketplace (e.g., a website, electronic application, widget, etc.) that allows users to search, browse, view and/or acquire (i.e., purchase, rent, lease, borrow, download, etc.) recipes. In some embodiments, the recipe service 118 may receive recipe data 114 corresponding to one or more recipes from user computing devices 102, other user computing devices 120, or a combination thereof. The recipe service 118 may then distribute the one or more recipes as recipe data 114 to user computing device 102, other user computing device 110, etc. In some embodiments, recipe service 118 may also receive and store consumption data 118 from user computing device 102. The recipe service 118 may also receive and store consumption data 124 corresponding to consumption information for other users 122 associated with other user computing devices 120. The consumption data 124 may identify the recipes that other users 122 made, ingredients used, amounts of ingredients, one or more times at which the ingredients were added, nutritional information for the added ingredients, brand or other identifiers associated with ingredients used, etc. FIG. 1 further illustrates each of the user computing device 102, appliance 106, recipe service 118 and other user computing devices 120s being connected to a network 138.

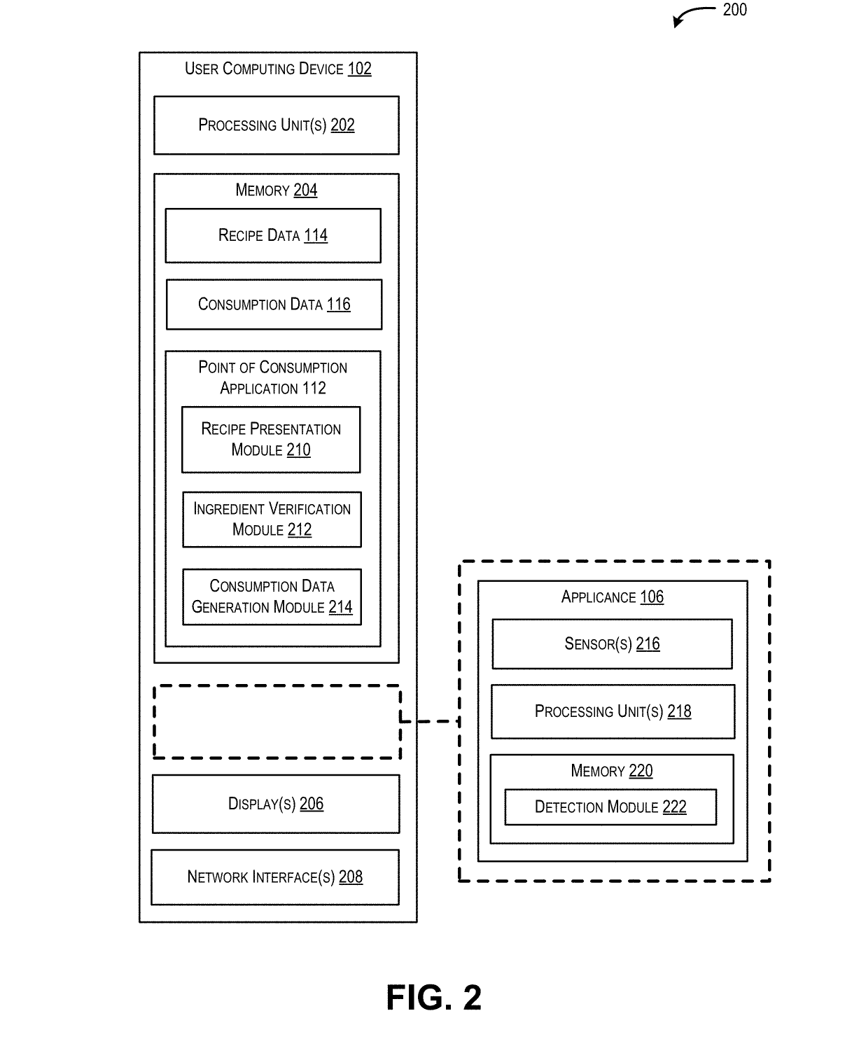

FIG. 2 is an illustrative computing architecture 200 of a computing device configured to capture and store corroborated point of consumption (POC) data for food consumed by an individual. The computing architecture 200 may be used to implement the various systems, devices, and techniques discussed herein. In various embodiments, user computing device 102 may be implemented on any type of device, such as a laptop computer, personal computer, voice controlled computing device a tablet device, a mobile telephone, etc.

In the illustrated implementation, the computing architecture 200 includes one or more processing units 202 coupled to a memory 204. The computing architecture may also include a display 206 and/or network interface 208. FIG. 2 further illustrates appliance 106 as being separate from user computing device 102. However in some embodiments, appliance 106 may be incorporated as a component of the user computing device 102, or vice versa.

The user computing device 102 can include recipe data 114 and consumption data 116 stored on the memory 204. Recipe data 114 may include one or more recipes for making individual food or drink items. Some of the recipes may be modified versions of other recipes. The recipe data 114 may also include descriptions of ingredients used in the recipes. An ingredient may include any component of a recipe, including raw ingredients (e.g., eggs, butter, oats, carrots, chicken breast, etc.), and prepared ingredients (e.g., ice cream, butter, pasta sauce, etc.). The recipe data 114 may include descriptions of the ingredients and may include nutritional information, potential substitutions for the ingredient, categorization information (i.e., “milk” may be categorized within the category “dairy”), serving size, density, etc. The recipe data 114 may be received by the user computing device 102 from a recipe service, such as a website or application that allows users to search, browse, view and/or acquire recipes. The recipe data 114 may also be generated by the user computing device 102 based on inputs received from a user.

The consumption data 116 may identify the ingredient, an amount added, one or more times related to the pour event (e.g., time the pour started, time the pour finished, duration of the pour event, etc.), nutritional information for the poured ingredient, a brand or other identifier associated with the ingredient, a user identifier associated with the individual preparing the recipe, an indication that the ingredient was verified by information from the appliance, etc.

The user computing device 102 can also include a point of consumption (POC) application 112 stored on the memory 204. The POC application 112 may be configured to present ingredients and/or recipes to a user based on recipe data 114, verify that ingredients were added to the recipe based on verification data from one or more appliances 106, and generate verified consumption data 116 for the verified ingredients.

The POC application 112 may include recipe presentation module 210, ingredient verification module 212, and consumption data generation module 214. As used herein, the term “module” is intended to represent example divisions of executable instructions for purposes of discussion, and is not intended to represent any type of requirement or required method, manner or organization. Accordingly, while various “modules” are described, their functionality and/or similar functionality could be arranged differently (e.g., combined into a fewer number of modules, broken into a larger number of modules, etc.). Further, while certain functions and modules are described herein as being implemented by software and/or firmware executable on a processor, in other instances, any or all of the modules can be implemented in whole or in part by hardware (e.g., a specialized processing unit, etc.) to execute the described functions. In various implementations, the modules described herein in association with user computing device 102 can be executed across multiple devices.

The recipe presentation module 210 can be executable by the one or more processing units 202 to provide one or more functionalities to guide a user through the processes of making a recipe. In some embodiments, the functionalities for guiding a user through the processes of making a recipe may include a graphical recipe interface, a series of visual and/or audio signals for guiding an individual through a recipe, or a combination thereof. For example, the application may present a graphical recipe interface that includes a recipe step that a certain amount of an ingredient is to be added to a container that is on a kitchen scale. As a further example, for individual steps of a recipe, the recipe presentation module 208 may cause user computing device 102 to present an audio instruction to perform the step. Alternatively or in addition, the recipe presentation module 208 may cause a graphical recipe interface to be presented on display 206, where the graphical recipe interface presents one or more recipe steps that are to be performed. For example, the graphical recipe interface may include an ingredient block corresponding to an ingredient of the recipe. The recipe presentation module 208 may also cause an animation of the ingredient block being slowly filled in response to the user computing device 102 receiving verification data from appliance 106 that is indicative of the weight or amount of the ingredient corresponding to the ingredient block being added.

The ingredient verification module 212 can be executable by the one or more processing units 202 to verify that an ingredient has been added based on verification data from one or more appliances 106. Ingredient verification module 212 may receive verification data 110 corresponding to a recipe ingredient from appliance 106. For example, where appliance 106 includes a sensor 216 for determining mass, sensor 216 may detect a change in mass of a container and transmit verification data 110 corresponding to the change of mass for use by the ingredient verification module 212. In another example, sensor 106 may detect a return signal from an RFID device associated with a container holding an ingredient, and transmit verification data 110 indicating that the ingredient was sensed to be within a proximity of appliance 106. The verification data 110 may be transmitted from appliance 106 to user computing device 102 via a wired or wireless connection. In some embodiments, where the user computing device 102 is integrated into appliance 106 (or vice versa), the verification data 110 may be passed between one or more sensors 216 of the appliance 106 and the ingredient verification module 212 via one or more internal connections.

When verifying that the ingredient has been added, the ingredient verification module 212 may compare the sensor data included in the verification data 110 to expected sensor information for the ingredient. For example, the ingredient verification module 212 may know a change in mass that is to be expected when an ingredient is added (e.g., 2 cups of milk has a mass of 245 grams), and may compare the verification data to the expected mass. If the verification data 110 indicates that the sensor data is within a threshold range of similarity (e.g., plus or minus a threshold percentage, a threshold numerical amount, etc.), then the ingredient verification module 212 may verify the ingredient as having been added. If the verification data 110 is outside the threshold range, ingredient verification module 212 may determine that the sensor data is indicative of a mistake by the user (i.e., the user added too much or too little of an ingredient), and the ingredient verification module 212 may cause an alert to be provided to the user. Alternatively or in addition, the ingredient verification module 212 may present a notification to the user that there has been a mistake, and/or present a suggested action for the user to take fix the mistake (e.g., adjust the proportions of other ingredients within the recipe to compensate for the mistake).

In some embodiments, when the verification data 110 is outside the threshold range of expected sensor data for an ingredient, ingredient verification module 212 may check to see if the recipe includes another ingredient that has expected sensor data that matches the sensor data in the verification data 110. For example, where a change of mass is 162 grams the ingredient verification module 212 may determine that the ingredient added by the user is not “one teaspoon of baking soda” (expected sensor data being roughly 11 grams). The ingredient verification module 212 may then determine that the recipe includes the ingredient “three quarter cup of brown sugar,” which has an expected sensor data of 165 grams. The ingredient verification module 212 may then verify that 162 grams of brown sugar has been added by the user.

In some embodiments, the ingredient verification module 212 may also be able to verify ingredients that the individual has added without interacting with appliance 106. For example, the ingredient verification module 212 may verify that an ingredient has been added based on received audio input (or other type of input) that the ingredient has been added. Alternatively or in addition, the POC application 112 may present a graphical user interface that allows a user to input ingredients that have been added, and the ingredient verification module 212 may verify ingredients based on input received via the graphical user interface.

The ingredient verification module 212 may also verify that one or more ingredients have been added based on a determination that a recipe has been completed. For example, ingredient verification module 212 may determine that a recipe is complete when a threshold amount of the recipe is completed. In various embodiments the threshold amount may correspond to a number of verified ingredients added, a percentage of ingredients being verified, a preset value, etc. For example, the ingredient verification module 212 may assign a completion value for each ingredient that is verified, and may determine that a recipe is complete when the cumulative value of the completion values for verified ingredients meets or exceeds a threshold value associated with the recipe. In some embodiments, the ingredient verification module 212 may weight the completion value for an ingredient based on a level of confidence that the ingredient was added. Alternatively or in addition, the threshold value may be preset, or may be determined based on a behavior history of a user. The ingredient verification module 212 may also determine that a recipe is complete based on input received by the user computing device 102 via a gesture, voice command, a physical interface, a graphical user interface, or based on sensor information included in verification data from appliance 106.

The consumption data generation module 214 can be executable by the one or more processing units 106 to generate verified consumption data 116 for the verified ingredients. The consumption data generation module 214 may generate consumption data 116 based on the sensor data included within the verification data 110 received from appliance 106. For example, if the recipe calls for 210 g of chicken breast (i.e., one chicken breast) to be added, but the verification data 110 indicates that 198 g was detected by sensor 216, the consumption data generation module 214 may generate consumption data for 198 g of chicken breast. In other words, the consumption data generation module 214 may generate consumption data that corresponds to the actual amount of ingredient that is added by the user, and not the amount of the ingredient called for by a recipe.

FIG. 2 further depicts appliance 106. Appliance 106 may be a scale, oven, blender, mixer, refrigerator, food thermometer, or other type of tool used to store and/or prepare food. Appliance 106 may include one or more sensors 216 that detect evidence of ingredients being added and/or recipe steps being executed. Sensors 216 may include any combination of one or more optical sensors (e.g., camera, barcode scanner, etc.), pressure sensors (e.g., capacitance sensors, piezoelectric sensors, etc.), acoustic sensors (e.g., microphones, etc.), or other sensors capable of receiving input or other otherwise detecting characteristics of appliance 106 and/or the environment of appliance 106.

In some embodiments, appliance 106 may further include processing unit(s) 218, and memory 220. The user computing device 102 can include a detection module 222 stored on the memory 220. The detection module 222 can be executable by the one or more processing units 218 to monitor sensor data from sensors 116 and transmit the sensor data to the user computing device 102.

Those skilled in the art will appreciate that the architecture described in association with user computing device 102 and appliance 106 are merely illustrative and is not intended to limit the scope of the present disclosure. In particular, the computing system and devices may include any combination of hardware or software that can perform the indicated functions, including computers, network devices, internet appliances, and/or other computing devices. The user computing device 102 and appliance 106 may also be connected to other devices that are not illustrated, or instead may operate as a stand-alone system. In addition, the functionality provided by the illustrated components may in some implementations be combined in fewer components or distributed in additional components. Similarly, in some implementations, the functionality of some of the illustrated components may not be provided and/or other additional functionality may be available.

The one or more processing unit(s) 202 and 218 may be configured to execute instructions, applications, or programs stored in the memory 204. In some examples, the one or more processing unit(s) 202 and 218 may include hardware processors that include, without limitation, a hardware central processing unit (CPU), a graphics processing unit (GPU), and so on. While in many instances the techniques are described herein as being performed by the one or more processing units 202 and 218, in some instances the techniques may be implemented by one or more hardware logic components, such as a field programmable gate array (FPGA), a complex programmable logic device (CPLD), an application specific integrated circuit (ASIC), a system-on-chip (SoC), or a combination thereof.

The memory 204 and 220 is an example of computer-readable media. Computer-readable media may include two types of computer-readable media, namely computer storage media and communication media. Computer storage media may include volatile and non-volatile, removable, and non-removable media implemented in any method or technology for storage of information, such as computer readable instructions, data structures, program modules, or other data. Computer storage media includes, but is not limited to, random access memory (RAM), read-only memory (ROM), erasable programmable read-only memory (EEPROM), flash memory or other memory technology, compact disc read-only memory (CD-ROM), digital versatile disk (DVD), or other optical storage, magnetic cassettes, magnetic tape, magnetic disk storage or other magnetic storage devices, or any other non-transmission medium that may be used to store the desired information and which may be accessed by a computing device. In general, computer storage media may include computer-executable instructions that, when executed by one or more processing units, cause various functions and/or operations described herein to be performed.

Additionally, a computer media includes data stored within a modulated data signal. For example, a computer media may include computer readable instructions, data structures, program modules, modulated carrier waves, other modulated transmission mechanisms, etc. However, as defined herein, computer storage media does not include communication media.

Those skilled in the art will also appreciate that, while various items are illustrated as being stored in memory or storage while being used, these items or portions of them may be transferred between memory and other storage devices for purposes of memory management and data integrity. Alternatively, in other implementations, some or all of the software components may execute in memory on another device and communicate with the illustrated environment 200. Some or all of the system components or data structures may also be stored (e.g., as instructions or structured data) on a non-transitory, computer-accessible medium or a portable article to be read by an appropriate drive, various examples of which are described above. In some implementations, instructions stored on a computer-accessible medium separate from user computing device 102 and/or appliance 106 may be transmitted to user computing device 102 and/or appliance 106 via transmission media or signals such as electrical, electromagnetic, or digital signals, conveyed via a communication medium such as a wireless link. Various implementations may further include receiving, sending or storing instructions and/or data implemented in accordance with the foregoing description upon a computer-accessible medium.

Additionally, the network interface 206 includes physical and/or logical interfaces for connecting the respective computing device(s) to another computing device or network. For example, the network interface 208 may enable WiFi-based communication such as via frequencies defined by the IEEE 802.11 standards, short range wireless frequencies such as Bluetooth®, or any suitable wired or wireless communications protocol that enables the respective computing device to interface with the other computing devices.

The architectures, systems, and individual elements described herein may include many other logical, programmatic, and physical components, of which those shown in the accompanying figures are merely examples that are related to the discussion herein.

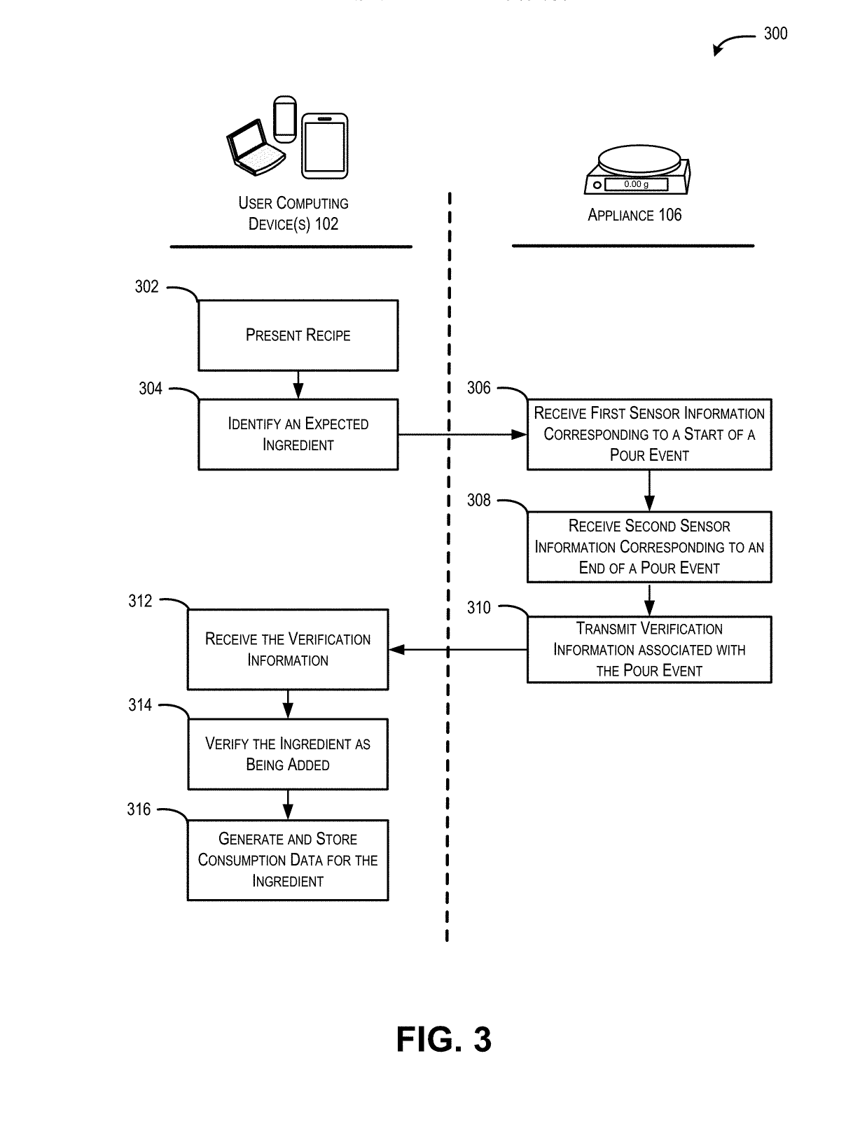

FIGS. 3, 5, 6, and 8 are flow diagrams of illustrative processes illustrated as a collection of blocks in a logical flow graph, which represent a sequence of operations that can be implemented in hardware, software, or a combination thereof. The blocks are organized under entities and/or devices that may implement operations described in the blocks. However, other entities/devices may implement some blocks. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes.

FIG. 3 is a flow diagram of an illustrative process 300 for generating corroborated point of consumption (POC) data for food consumed by an individual. The process 300 may be implemented by the computing architecture 200 and in the environment 100 described above, or in other environments and architectures.

At 302, user computing device 102 presents a recipe. A recipe may include a set of instructions for preparing a particular food or drink item. In some embodiments, presenting the recipe may include causing a graphical recipe interface to be presented on a display. In some embodiments, the graphical recipe interface presents one or more recipe steps/ingredients that are to be performed. The display may be part of the user computing device 102, or may be a component of another computing device. In embodiments where the user computing device 102 is incorporated as part of an appliance, the graphical recipe interface may be presented on a display incorporated into the appliance.

At 304, user computing device 102 identifies an expected ingredient. For example, the user computing device 102 may determine an ingredient that is to be next added during completion of the recipe. An ingredient may include any component of a recipe, including raw ingredients (e.g., eggs, butter, oats, carrots, chicken breast, etc.), and prepared ingredients (e.g., ice cream, butter, pasta sauce, etc.). The expected ingredient may be selected based on a predetermined recipe order, a suggested ingredient order (e.g., dry ingredients must be added before wet ingredients), past user behavior, contextual data, or other factors. In some embodiments, once the expected ingredient has been selected, the user computing device 102 may cause the graphical recipe interface to include an ingredient block corresponding to the expected ingredient. Alternatively or in addition, the user computing device 102 may cause an audio instruction to add the ingredient to be presented.

At 306, appliance 106 receives first sensor information corresponding to a start of a pour event. In some embodiments, the appliance may be a kitchen scale configured to detect that an ingredient is being added to a container. For example, where the user computing device has directed an individual to add an ingredient to a container, the kitchen scale may detect that the container has been placed onto the scale, and then detect a change in the mass of the container indicative of the ingredient being added.

At 308, appliance 106 receives second sensor information corresponding to an end of the pour event. In some embodiments, the second sensor information may correspond to the mass of the container becoming stable. For example, where the appliance 106 is a kitchen scale, and here the kitchen scale has detected a change in mass of the container indicative of an ingredient being added, the kitchen scale may detect that the mass of the container has remained stable for a set period of time.

At 310, appliance 106 transmits verification information 110 associated with the pour event to the user computing device 102. For example, appliance 106 may determine a portion of sensor data that is indicative of a pour event, and transmit the portion of data to the user computing device 102. Alternatively, transmitting the verification information 110 may include the appliance 106 may transmit all sensor data to the user computing device 102. The verification information 110 may be transmitted from appliance 106 to user computing device 102 via a wired or wireless connection. In some embodiments, where the user computing device 102 is integrated into appliance 106, the verification data 110 may be passed between one or more sensors of the appliance and a point of consumption application executing on the user computing device 102 via one or more internal connections.

At 312, user computing device 102 receives the pour event information from the appliance 106. For example, where appliance 106 is a kitchen scale and an ingredient is added to a container placed upon the kitchen scale, appliance 106 may transmit verification data 110 corresponding to one or more of the change of mass, an initial mass, a final mass, timing information for the pour event, etc.

At 314, user computing device 102 verifies the ingredient as being added. For example, the user computing device 102 may compare the sensor data included in the verification information 110 to expected sensor information for the expected ingredient. In some embodiments, the user computing device 102 may know a change in mass that is to be expected when an ingredient is added, and may compare the verification data 110 to the expected mass. The expected sensor information may be included within the recipe data for the recipe, or may be computed by the user computing device 102 using characteristics of the ingredient. For example, recipe data for the recipe may indicate that one teaspoon of baking soda has a mass of 11 grams. The user computing device 102 can then compute the expected sensor information for 2 tablespoons of baking soda using the ratio of 1 tsp.=11 g.

If the verification information 110 indicates that the sensor data is within a threshold range of similarity (e.g., plus or minus a threshold percentage, a threshold numerical amount, etc.), then the user computing device 102 may verify the ingredient as having been added. If the verification information 110 is outside the threshold range, the user computing device 102 may determine that the sensor data is indicative of a mistake by the user (i.e., the user added too much or too little of an ingredient), and the user computing device 102 may cause an alert to be provided to the user. Alternatively or in addition, the user computing device 102 may present a notification to the user that there has been a mistake, and/or present a suggested action for the user to take fix the mistake (e.g., adjust the proportions of other ingredients within the recipe to compensate for the mistake).

At 316, user computing device 102 generates and stores consumption data for the ingredient. In some embodiments, the generated consumption data may correspond to the actual amount indicated in the verification information 110. For example, if the recipe calls for 210 g of chicken breast (i.e., one chicken breast) to be added, but the verification information 110 indicates that 198 g was detected by appliance 106, the consumption data generation module 214 may generate consumption data for 198 g of chicken breast. In other words, the user computing device 102 may generate consumption data that corresponds to the actual amount of ingredient that is added by the user, and not the amount of the ingredient called for by a recipe. In some embodiments, the consumption data may identify the ingredient, an amount added, one or more times related to the pour event (e.g., time the pour started, time the pour finished, duration of the pour event, etc.), nutritional information for the poured ingredient, a brand or other identifier associated with the ingredient, a user identifier associated with the individual preparing the recipe, an indication that the ingredient was verified by information from the appliance, etc.

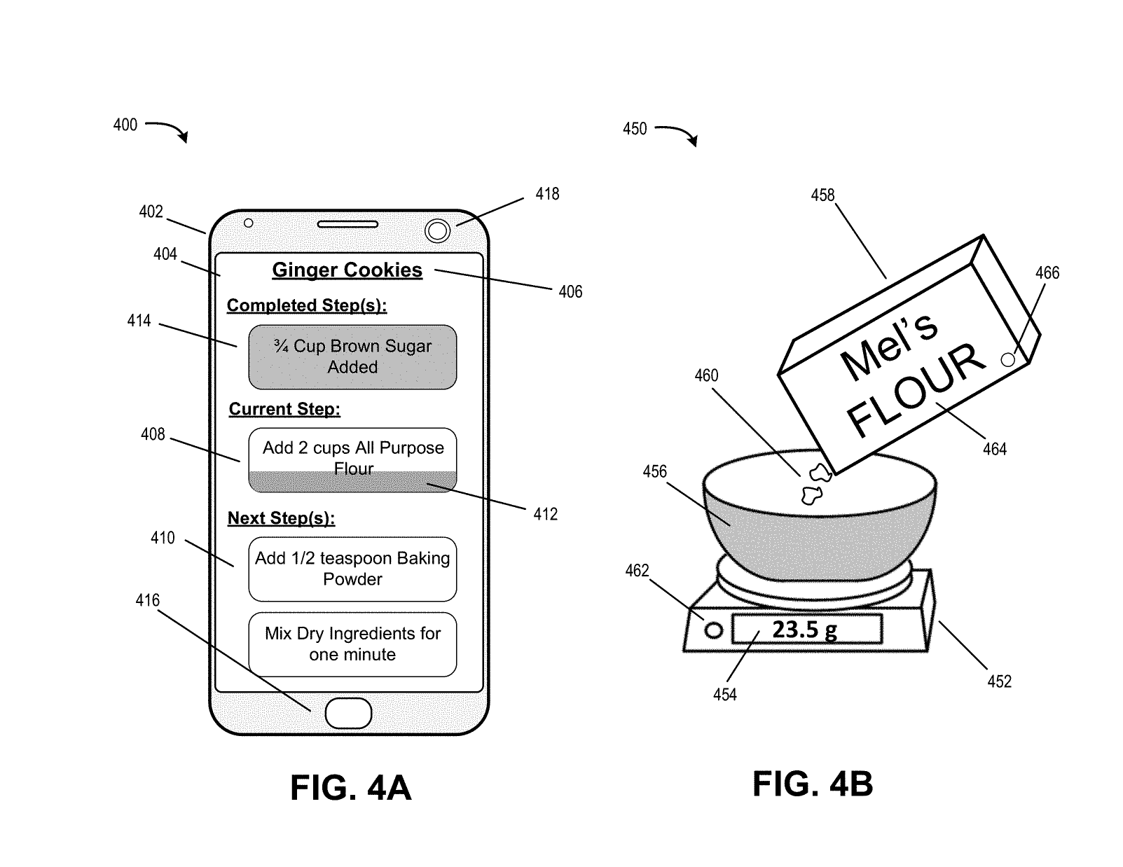

FIGS. 4A and 4B are example illustrations 400 and 450 of a user computing device and an appliance configured to capture corroborated point of consumption (POC) data for food consumed by a user. While the user computing device and the appliance are depicted as being separate entities, a person having ordinary skill would understand that in some embodiments one or more of the components described as being a part of user computing device and the appliance may be integrated into a single device.

FIG. 4A illustrates an exemplary environment 400 for guiding a user through the completion of a recipe. FIG. 4A depicts a user computing device 402 presenting a recipe interface on a display 404. FIG. 4A depicts user computing device 402 as a smartphone, but in different embodiments the user computing device 402 may be any type of computing device (e.g., tablet, personal computer, laptop, voice controlled computing device, server system, etc.) able to present an interface, or cause the presentation of a recipe interface to occur on a display on a separate device.

The recipe interface may present a recipe 406. In some embodiments, the recipe interface may present one or more steps 408 and 410. The steps may correspond to instructions to add ingredients and/or perform actions during the course of making the recipe.

The recipe interface may include a current step 408 that the user is to perform. In some embodiments, the user computing device 402 may be configured to receive verification data from an appliance associated with the current step 408. For example, when the current step 408 corresponds to an ingredient to be added, the user computing device 402 may receive verification data from a scale that indicates a change in the mass of a container indicative of an ingredient being added to the container. In some embodiments, the current step 408 may be presented as an unfilled block, and as the user computing device 402 receives verification data indicative of such a change in mass, the user computing device 402 may present an animation effect 412 where the empty block is filled in accordance with the verification data. For example, if the current step calls for the user to add 2 cups of all purpose flour, and the verification data indicates a change in mass corresponding to 1 cup of flour being added (i.e. approximately 120 grams), then the animation effect 412 may cause the block to be presented as half filled. In another example, where a step may be to mix ingredients for a period of time, when the user computing device receives verification data indicative of an electric mixer being started, the user computing device 402 may present a timer or animation to assist the user in mixing for the correct amount of time. The user computing device 402 may also include one or more sensors 414 and 416 for detecting audio and visual inputs. The user computing device 402 may also be configured to receive inputs via a physical interface (e.g., buttons, keyboard, etc.) and/or the display (i.e., via a touchscreen).

FIG. 4B illustrates an exemplary environment 450 where an appliance detects information indicative of the completion of an ingredient step, and transmits verification information to corroborate the completion of the ingredient step. FIG. 4B depicts an appliance 452 having a display 454. FIG. 4B depicts appliance 452 as a scale, but in other embodiments the appliance may be an oven, blender, mixer, refrigerator, food thermometer, another type of tool used to store and/or prepare food/drinks, or a combination thereof.

FIG. 4B further depicts a container 456 placed atop the scale and an ingredient 458, where a portion of the ingredient 460 is being added to the container 456. As the portion of the ingredient 460 is added to the container 456, the appliance 452 is able to detect a change in mass of the container 456, and may transmit verification data 110 indicating the change of mass. In this way, an entity receiving the verification data 110 can corroborate that addition of the ingredient occurred using physical evidence that the ingredient was added. Additionally, the receiving entity can also generate consumption data that reflects the actual amount of the ingredient that was actually added by a user.

In some embodiments, appliance 452 may include a sensor 462 to capture brand information 464 for the ingredient 458. For example, the sensor may be a camera configured to capture an image of the ingredient. The verification data may include the captured image, or may include one or more characteristics (e.g., packaging, dimensions, colors, brand, labels, etc.) that are determined from the image. The sensor 462 may be configured to capture information included, conveyed, or otherwise associated with a tag 466 located on ingredient 458. Tag 466 may be a visual tag (e.g., a barcode, QR code, etc.) or another type of tag configured to identify an ingredient or otherwise convey information associated with the ingredient (e.g., RFID, embedded chip, etc.).

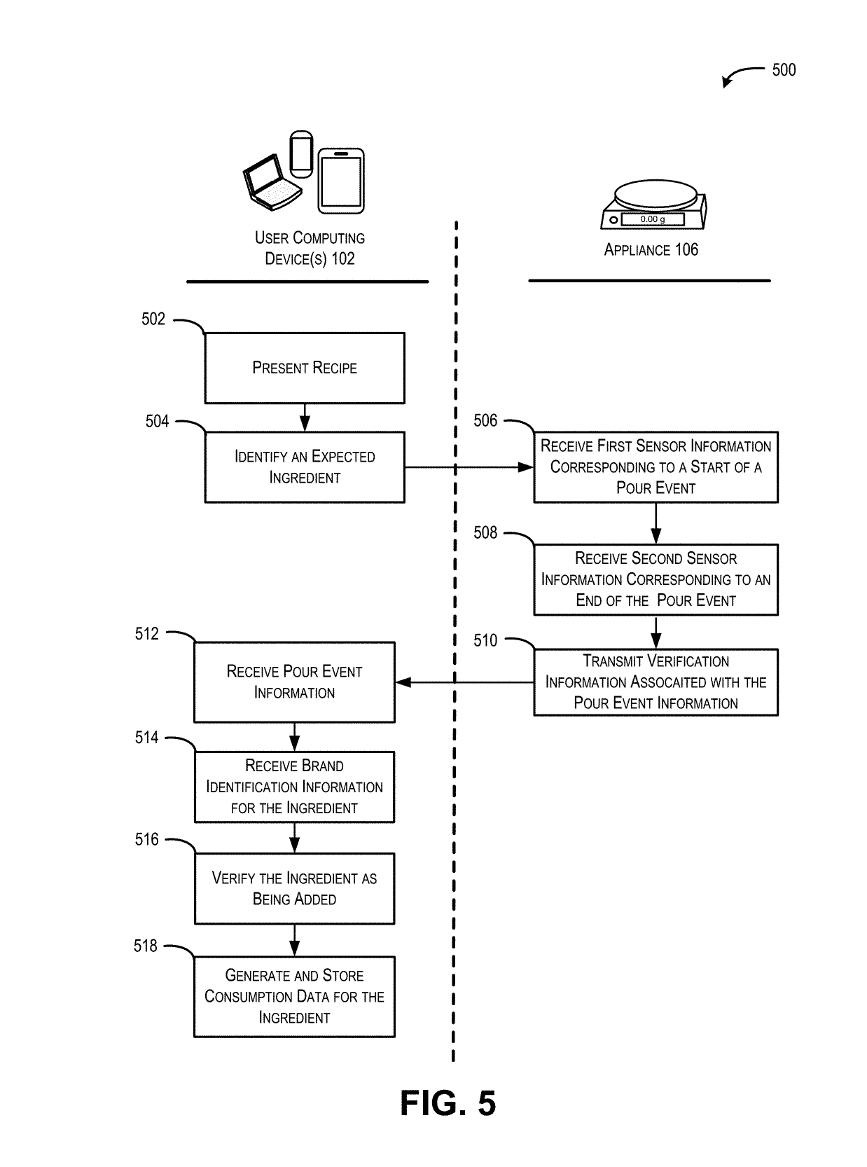

FIG. 5 is a flow diagram of an illustrative process 500 for generating corroborated point of consumption (POC) data for food consumed by an individual that includes brand information. The process 500 may be implemented by the computing architecture 200 and in the environment 100 described above, or in other environments and architectures.

At 502, user computing device 102 presents a recipe. A recipe may include a set of instructions for preparing a particular food or drink item. In some embodiments, presenting the recipe may include causing a graphical recipe interface to be presented on a display. In some embodiments, the graphical recipe interface presents one or more recipe steps/ingredients that are to be performed. The display may be part of the user computing device 102, or may be a component of another computing device. In embodiments where the user computing device 102 is incorporated as part of an appliance, the graphical recipe interface may be presented on a display incorporated into the appliance.

At 504, user computing device 102 identifies an expected ingredient. For example, the user computing device 102 may determine an ingredient that is to be next added during completion of the recipe. An ingredient may include any component of a recipe, including raw ingredients (e.g., eggs, butter, oats, carrots, chicken breast, etc.), and prepared ingredients (e.g., ice cream, butter, pasta sauce, etc.). The expected ingredient may be selected based on a predetermined recipe order, a suggested ingredient order (e.g., dry ingredients must be added before wet ingredients), past user behavior, contextual data, or other factors. In some embodiments, once the expected ingredient has been selected, the user computing device 102 may cause the graphical recipe interface to include an ingredient block corresponding to the expected ingredient. Alternatively or in addition, the user computing device 102 may cause an audio instruction to add the ingredient to be presented.

At 506, appliance 106 receives first sensor information corresponding to a start of a pour event. In some embodiments, the appliance may be a kitchen scale configured to detect that an ingredient is being added to a container. For example, where the user computing device has directed an individual to add an ingredient to a container, the kitchen scale may detect that the container has been placed onto the scale, and then detect a change in the mass of the container indicative of the ingredient being added.

At 508, appliance 106 receives second sensor information corresponding to an end of the pour event. In some embodiments, the second sensor information may correspond to the mass of the container becoming stable. For example, where the appliance 106 is a kitchen scale, and here the kitchen scale has detected a change in mass of the container indicative of an ingredient being added, the kitchen scale may detect that the mass of the container has remained stable for a set period of time.

At 510, appliance 106 transmits verification information 110 associated with the pour event to the user computing device 102. For example, appliance 106 may determine a portion of sensor data that is indicative of a pour event, and transmit the portion of data to the user computing device 102. Alternatively, transmitting the verification information 110 may include the appliance 106 may transmit all sensor data to the user computing device 102. The verification information may be transmitted from appliance 106 to user computing device 102 via a wired or wireless connection. In some embodiments, where the user computing device 102 is integrated into appliance 106, the verification data 110 may be passed between one or more sensors of the appliance and a point of consumption application executing on the user computing device 102 via one or more internal connections.

At 512, user computing device 102 receives the pour event information from the appliance 106. For example, where appliance 106 is a kitchen scale and an ingredient is added to a container placed upon the kitchen scale, appliance 106 may transmit verification data 110 corresponding to one or more of the change of mass, an initial mass, a final mass, timing information for the pour event, etc.

At 514, user computing device 102 receives brand identification information for the ingredient. User computing device 102 may receive brand information from appliance 106. The brand identification information may include information that describes the flavor, maker, container size, brand, variety, or other specific information about the ingredient that is actually added by the user. For example, brand information may indicate that the flour that the user added was Mel's Organic Flour, and/or that the flour added by the user was bread flour. The user computing device 102 may additionally or as an alternative receive brand identification information via a captured user gesture, voice command, physical interface, graphical user interface, or other sensor information. The user computing device 102 may additionally or as an alternative receive brand information from recipe service 118, and/or from another public, commercial, or private source accessible via network 138.

In some embodiments, user computing device 102 or appliance 106 may include a sensor configured to detect brand information. For example, the sensor may be able to capture images of the ingredient being added, scan a universal product code (e.g., barcode, QR code, etc.) or other label associated with the ingredient, and obtain information associated with the ingredient. In an embodiment, the sensor may be configured to detect a signal from an RFID device associated with a container holding an ingredient, and obtain information associated with the ingredient. Additionally or as an alternative, the user computing device 102 may determine brand identification information based on ingredients that the user is known to have on hand. For example, the user computing device 102 may store one or more of ingredients purchased by a user, ingredients previously included in a shopping list ingredients that were previously used, scanned, or otherwise identified by the user computing device 102.

At 516, user computing device 102 verifies the ingredient as being added. For example, the user computing device 102 may compare the sensor data included in the verification information 110 to expected sensor information for the expected ingredient. In some embodiments, the user computing device 102 may know a change in mass that is to be expected when an ingredient is added, and may compare the verification data 110 to the expected mass. The expected sensor information may be included within the recipe data for the recipe, or may be computed by the user computing device 102 using characteristics of the ingredient. For example, recipe data for the recipe may indicate that one teaspoon of baking soda has a mass of 11 grams. The user computing device 102 can then compute the expected sensor information for 2 tablespoons of baking soda using the ratio of 1 tsp.=11 g.

If the verification information 110 indicates that the sensor data is within a threshold range of similarity (e.g., plus or minus a threshold percentage, a threshold numerical amount, etc.), then the user computing device 102 may verify the ingredient as having been added. If the verification information 110 is outside the threshold range, the user computing device 102 may determine that the sensor data is indicative of a mistake by the user (i.e., the user added too much or too little of an ingredient), and the user computing device 102 may cause an alert to be provided to the user. Alternatively or in addition, the user computing device 102 may present a notification to the user that there has been a mistake, and/or present a suggested action for the user to take fix the mistake (e.g., adjust the proportions of other ingredients within the recipe to compensate for the mistake).

At 518, user computing device 102 generates and stores consumption data for the ingredient. In some embodiments, the generated consumption data may correspond to the actual amount indicated in the verification information 110. For example, if the recipe calls for 210 g of chicken breast (i.e., one chicken breast) to be added, but the verification information 110 indicates that 198 g was detected by the appliance 106, the consumption data generation module 214 may generate consumption data for 198 g of chicken breast. In other words, the user computing device 102 may generate consumption data that corresponds to the actual amount of ingredient that is added by the user, and not the amount of the ingredient called for by a recipe. In some embodiments, the consumption data may identify the ingredient, an amount added, one or more times related to the pour event (e.g., time the pour started, time the pour finished, duration of the pour event, etc.), nutritional information for the poured ingredient, a brand or other identifier associated with the ingredient, a user identifier associated with the individual preparing the recipe, an indication that the ingredient was verified by information from the appliance, etc.

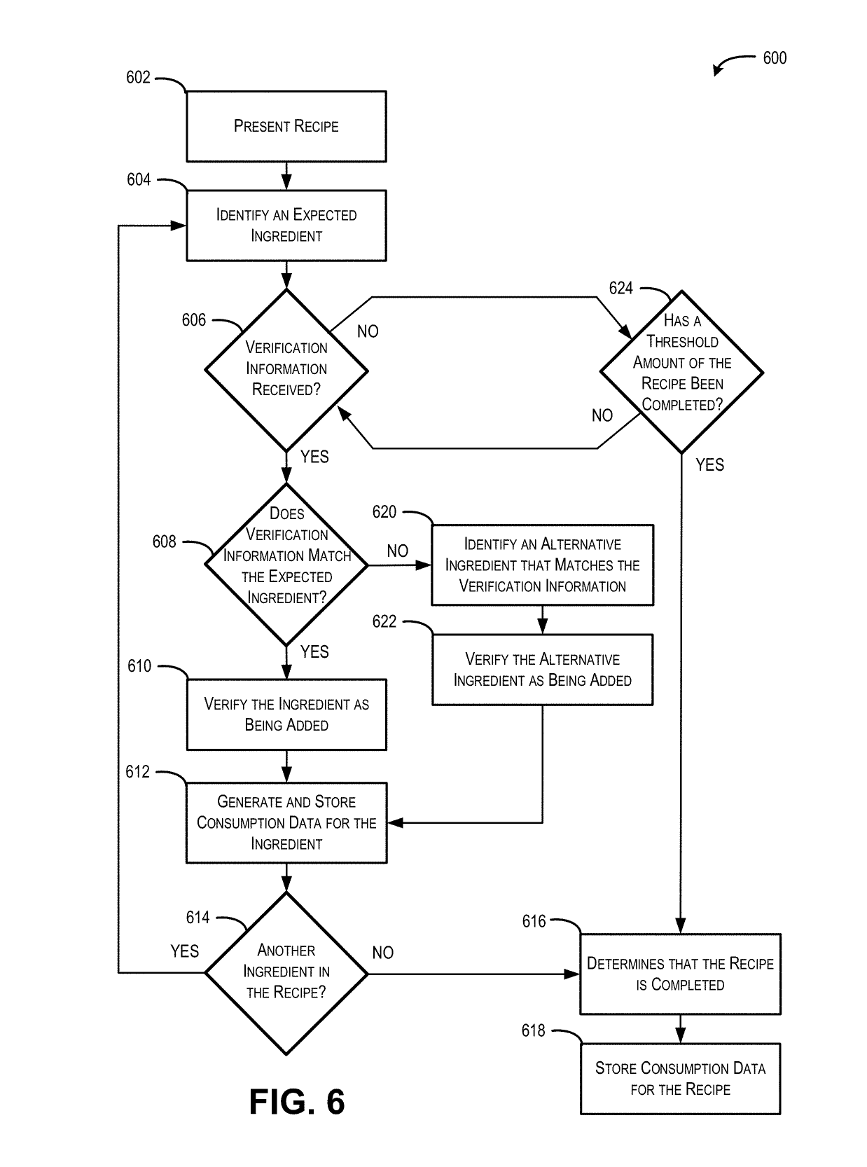

FIG. 6 is a flow diagram of an illustrative process 600 for generating corroborated point of consumption (POC) data for food consumed by an individual using a POC application. The process 600 may be implemented by the computing architecture 200 and in the environment 100 described above, or in other environments and architectures.

At 602, a point of consumption (POC) application presents a recipe. A recipe may include a set of instructions for preparing a particular food or drink item. In some embodiments, presenting the recipe may include causing a graphical recipe interface to be presented on a display. In some embodiments, the graphical recipe interface presents one or more recipe steps that are to be performed. The display may be part of a user computing device, or may be a component of another computing device.

At 604, POC application 112 identifies an expected ingredient. For example, the POC application 112 may determine an ingredient that is to be next added during completion of the recipe. An ingredient may include any component of a recipe, including raw ingredients (e.g., eggs, butter, oats, carrots, chicken breast, etc.), and prepared ingredients (e.g., ice cream, butter, pasta sauce, etc.). The expected ingredient may be selected based on a predetermined recipe order, a suggested ingredient order (e.g., dry ingredients must be added before wet ingredients), past user behavior, contextual data, or other factors. In some embodiments, once the expected ingredient has been selected, the POC application 112 may cause a graphical recipe interface to include an ingredient block corresponding to the expected ingredient. Alternatively or in addition, the POC application 112 may cause an audio instruction to add the ingredient to be presented.

At operation 606, POC application 112 determines whether verification information 110 has been received. In some embodiments, the verification information 110 may correspond to sensor information from one or more sensors incorporated within an appliance, a user computing device, other computing devices, or a combination thereof. For example, the verification information 110 may correspond to a user adding an ingredient to a container on a scale, turning on a blender, preheating an oven, etc.

If the answer at operation 606 is “yes” (it is determined that the verification data 110 has been received), then the process 600 moves to an operation 608 and the POC application 112 determines whether the verification information 110 matches the expected ingredient. In some embodiments, the POC application 112 may compare the sensor data included in the verification data 110 to expected sensor information for the expected ingredient. For example, where the appliance is a scale, the POC application 112 may know a change in mass that is to be expected when the expected ingredient is added to the scale. The expected sensor information may be included within the recipe data for the recipe, or may be computed by the user computing device 102 using characteristics of the ingredient. For example, recipe data for the recipe may indicate that one teaspoon of baking soda has a mass of 11 grams. The user computing device 102 can then compute the expected sensor information for 2 tablespoons of baking soda using the ratio of 1 tsp.=11 g. The POC application 112 may then compare the verification data 110 to this expected mass to determine if the mass indicated by the verification data 110 is within a threshold range of similarity (e.g., plus or minus a threshold percentage, a threshold numerical amount, etc.).

If the answer at operation 608 is “yes” (it is determined that the verification data 110 matches the expected ingredient), then the process 600 moves to an operation 610 and POC application 112 verifies the ingredient as being added. For example, if the verification data 110 indicates that the sensor data is within a threshold range of what would be expected for the ingredient, then the POC application 112 may verify the ingredient as having been added.

At 612, POC application 112 generates and stores consumption data for the ingredient. In some embodiments, the generated consumption data may correspond to the actual amount indicated in the verification information 110. In other words, the POC application 112 may generate consumption data that corresponds to the actual amount of ingredient that is added by the user, and not the amount of the ingredient called for by a recipe. The consumption data may identify the ingredient, an amount added, one or more times related to the pour event (e.g., time the pour started, time the pour finished, duration of the pour event, etc.), nutritional information for the poured ingredient, a brand or other identifier associated with the ingredient, a user identifier associated with the individual preparing the recipe, an indication that the ingredient was verified by information from the appliance, etc.

At operation 614, POC application 112 determines whether there remains another ingredient to be added to the recipe. If the answer at operation 614 is “yes” (it is determined that there are one or more ingredients remaining to be added to the recipe), then the process 600 moves to an operation 604, and an ingredient of the one or more ingredients is identified as being expected. If the answer at operation 614 is “no” (it is determined that there are not remaining ingredients in the recipe), then the process 600 moves to an operation 616, and the POC application 112 determines that the recipe is completed.

At 618, POC application 112 stores consumption data for the completed recipe. The generated consumption data may correspond to the actual amount of each ingredient indicated and/or verified by the verification information 110. In other words, the POC application 112 may generate consumption data for the recipe that reflects the actual ratios/amounts of ingredients that was used user to make the recipe, and not merely the amounts of each ingredient called for by a recipe.

If the answer at operation 608 is “no” (it is determined that the verification information 110 matches the expected ingredient), then the process 600 moves to the operation 620, and the POC application 112 identifies an alternative ingredient that matches the verification information 110. For example, when the verification information 110 is outside the threshold range of expected sensor data for the expected ingredient, the POC application 112 may check to see if the recipe includes another ingredient that has expected sensor data that matches the sensor data in the verification information 110. For example, where verification information 110 indicates a change of mass of 85 grams, the POC application 112 may determine that the ingredient added by the user is not “two sticks of butter” (expected sensor data being roughly 225 grams). The POC application 112 may then determine that the recipe includes the ingredient “one cup of oats,” which has an expected sensor data of 90 grams.

At 622, POC application 112 verifies the alternative ingredient as being added. For example, in the example described with regard to operation 620, the POC application 112, may use the verification information 110 to verify that 85 grams of oats have been added by the user. The process then continues at 612, where POC application 112 generates and stores consumption data for the alternative ingredient.

If the answer at operation 606 is “no” (it is determined that the verification information 110 has not been received), then the process 600 moves to the operation 624, and the POC application 112 determines whether a threshold amount of the recipe has been completed. For example, POC application 112 may determine whether the portion of the recipe that has been completed (i.e., the ingredients and/or recipe steps that have been corroborated/verified) is greater than or less than a threshold. In various embodiments, the threshold amount may correspond to a number of verified/corroborated ingredients, a percentage of ingredients being verified/corroborated, a preset value, etc. The threshold value may be preset, or may be determined based on one or more factors, including complexity of the recipe, behavior of other users who have made the recipe, the relative importance of individual ingredients, a behavior history of a user, etc. For example, the threshold may be lower for a recipe where a majority of the ingredients are garnishes and/or additions to taste, since most users feel comfortable adding garnishes and or seasonings without using a kitchen appliance that verifies their actions, and/or because these types of ingredients do not contribute much to the overall nutritional information for a recipe.

In some embodiments, the POC application 112 may assign a completion value to each ingredient that is verified. The POC application 112 may then determine that a recipe is complete when the cumulative value of the completion values for the verified ingredients meets or exceeds a threshold value associated with the recipe. A completion value assigned to a verified ingredient may be a preset value (e.g., all steps are equal to the same value, individual steps have preset values associated with them, etc.) or they may be determined by the POC application 112 based on one or more factors, including user behavior history, quantity of an ingredient, relative importance of an ingredient to a recipe, behavior history of other users who have made the recipe, nutritional traits of the ingredient, etc. For example, for a recipe for a “Manhattan Cocktail,” the POC application 112 may assign a higher completion value to verifications that 2 oz. of rye whiskey or 1 oz. of vermouth have been added than to a verification that 2 dashes of angostura bitters have been added. This may be because of the relative ease at which bitters may be added off the scale, because the user (or other users) have previously not verified the addition of bitters when making a Manhattan Cocktail, or because recipe data for the “Manhattan Cocktail” indicates that whiskey and vermouth are more important to the recipe. In another embodiment, the POC application 112 may weight a completion value that is preassigned to an ingredient based on a level of confidence that the ingredient was added.

Alternatively or in addition, the recipe data for some recipes may indicate some ingredients as being optional, while other ingredients may be identified as required. Then, when the POC application 112 is determining that a recipe is complete, verifying all the ingredients identified as being required may be a prerequisite for determining that the recipe has been completed. Alternatively or in addition, the POC application 112 may determine that a recipe is completed once all required ingredients have been verified. In some embodiments, a specific ingredient and/or recipe step may be identified in the recipe data as being associated with completion. For example, for a baking recipe preheating the oven may be identified as verifying completion of the recipe. Thus, when the POC application 112 receives verification information that an oven has been preheated to a correct temperature, the POC application 112 may determine that the recipe is complete. Once the POC application 112 determines that the recipe is complete, the POC application 112 may automatically verify that one or more ingredients for which no other verification information 110 have been received were completed. Alternatively, the recipe data may indicate whether individual ingredients are to be automatically verified.

If the answer at operation 624 is “no” (it is determined that a threshold amount of the recipe has not been completed), then the process 600 moves to an operation 606, where POC application 112 waits for additional verification information 110. If the answer at operation 624 is “yes” (it is determined that a threshold amount of the recipe has been completed), then the process 600 moves to an operation 616 and the POC application 112 marks the recipe as completed.

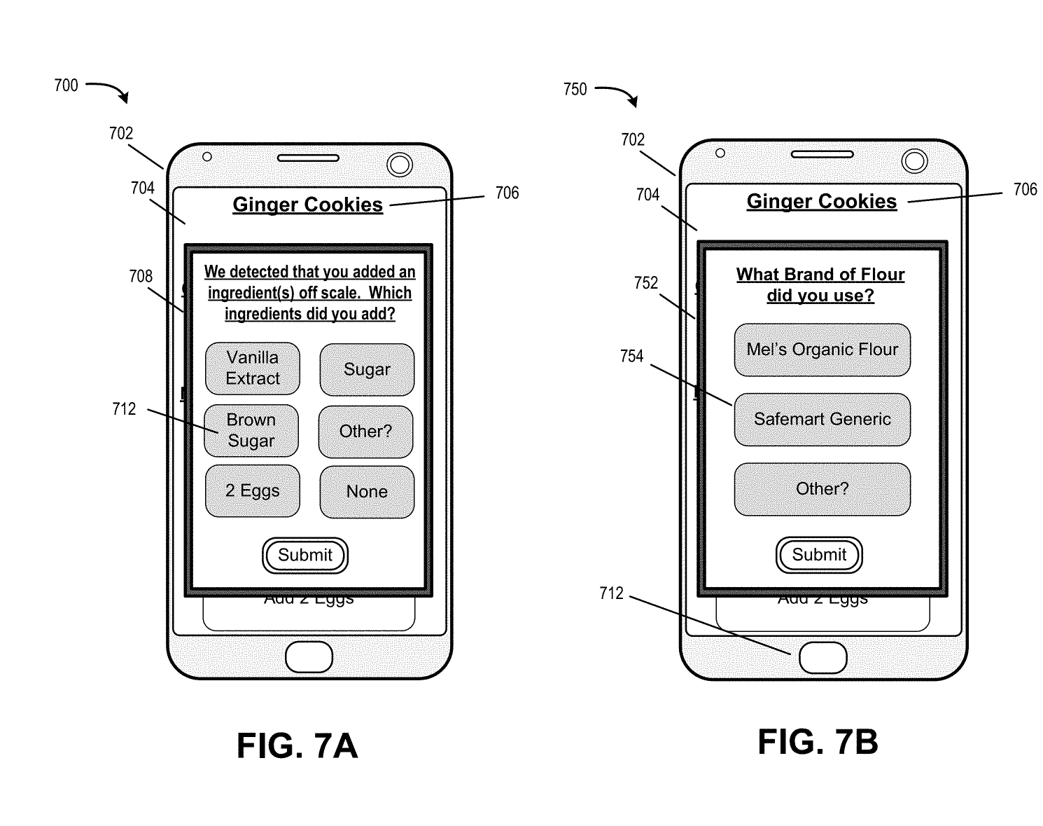

FIGS. 7A and 7B are example illustrations 700 and 750 of a user computing device to capture user input for corroborating ingredients added by a user. While the user computing device 102 and the appliance 106 are depicted as being separate entities, a person having ordinary skill would understand that in some embodiments one or more of the components described as being a part of user computing device and the appliance may be integrated into a single device.

FIGS. 7A and 7B depict a user computing device 702 presenting a recipe interface on a display 704. FIG. 7A depicts user computing device 702 as a smartphone, but in different embodiments the user computing device 702 may be any type of computing device (e.g., tablet, personal computer, laptop, voice controlled computing device, server system, etc.) able to present an interface, or cause the presentation of a recipe interface to occur on a display on a separate device.

FIG. 7A further illustrates a notification 708 that indicates that it has been detected that the user has added one or more ingredients for a recipe 706 for which verification information 110 was not captured. For example, first verification information 110 from a scale may indicate that a container on the scale has a mass of 640 grams, second verification information 110 from the scale may indicate that the container has been removed from the scale, and third verification information 110 may indicate that the container now has a mass of 800 grams. The user computing device 702 may determine based on this verification information 110 indicating a change of mass of 160 grams that one or more ingredients were added to the container while the container was removed from the scale. Alternatively, the user computing device 702 may receive verification information 110 that is indicative of the recipe 706 being completed (i.e., garnish being added to a cocktail, an oven being preheated, a blender being initiated, etc.), and may provide a notification 708 to allow the user to input any ingredients that the user added to the recipe 706, but were not verified by user computing device 702.

The notification 708 also presents one or more selectable options 710 for the user to indicate what ingredients were added. For example, the selectable options may correspond to suggested ingredients that the user may have added, categories of ingredients that the user can use to identify the ingredients they added (e.g., an “other” selectable element, a menu interface in which tiers of ingredients can be navigated, a text box that the user can use to type in the ingredient, etc.), and/or may allow the user to indicate that no ingredients were added. The user may input the one or more ingredients that were added via the notification 708, or may input them via other means such as a gesture, voice command, a physical interface, a graphical user interface, etc.

FIG. 7B further illustrates a notification 752 that presents selectable options 754 corresponding to potential brand information for an ingredient. For example, when user computing device 702 verifies that the user has added “flour” to the recipe 706, user computing device 702 may present notification 752 that asks the user for brand information, and allows the user to input brand information for the ingredient using the selectable options 754. In some embodiments, the user may input brand information using a gesture, voice command, a physical interface, a graphical user interface, etc. Alternatively or in addition, the user may be able to input the brand information by taking a picture of the ingredient container, scanning a barcode or QR code, or otherwise by manipulating the user computing device 702, an appliance 106, or the ingredient to cause a sensor to capture brand data for the ingredient.

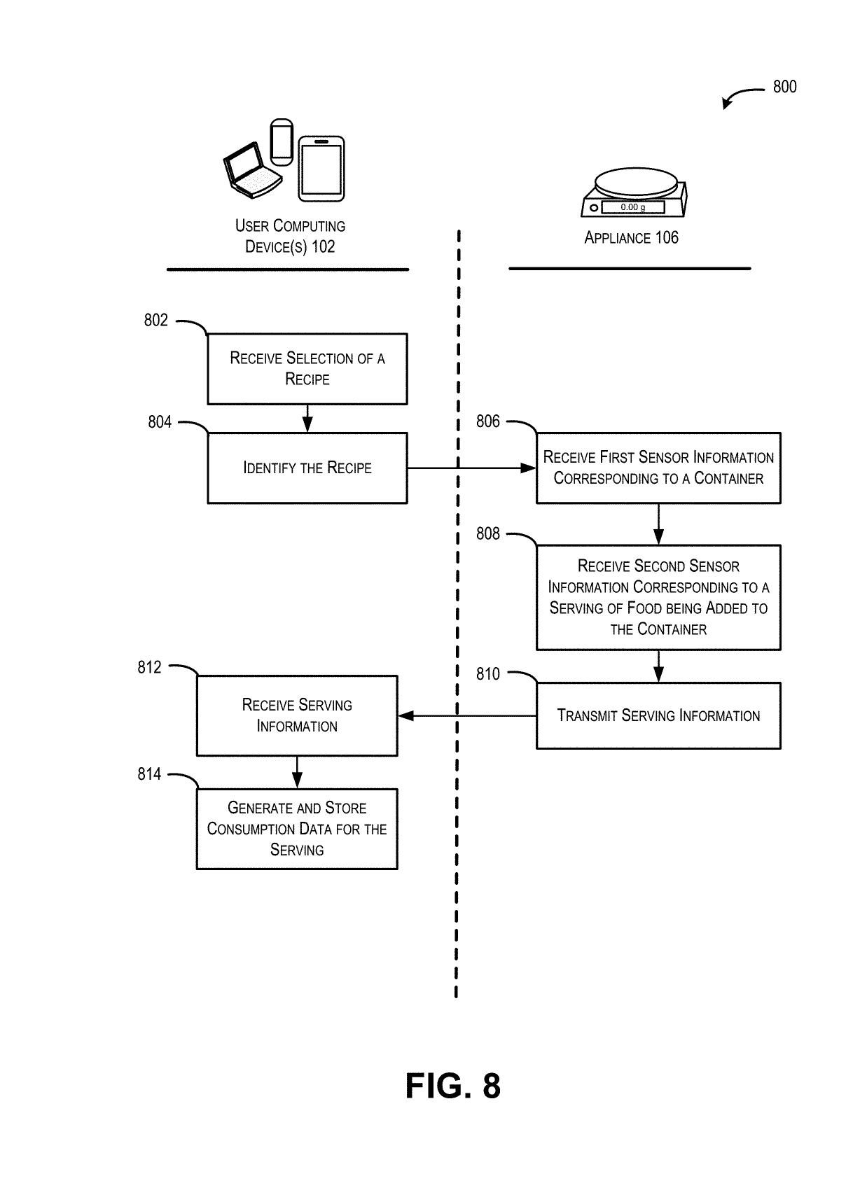

FIG. 8 is a flow diagram of an illustrative process 800 for generating corroborated point of consumption (POC) data for food consumed by an individual. The process 800 may be implemented by the computing architecture 200 and in the environment 100 described above, or in other environments and architectures.

At 802, user computing device 102 receives a selection of a recipe. The user computing device 102 may receive the selection of the recipe via a user input, such as a gesture, voice command, a physical interface, a graphical user interface, etc.

At 804, user computing device 102 identifies the recipe. For example, based on the user input, the user computing device may identify recipe data and or consumption data associated with the recipe. The recipe data may identify ingredients and nutritional information for individual food or drink items. The consumption data may identify the ingredients, ingredient amounts, nutritional information, etc. of food and drink items that were previously made by a user, and verified by a point of consumption (POC) application. For example, a user may have previously made lasagna using a POC application that verified the ingredients used to make the lasagna and generated consumption data describing nutritional information specifically for the lasagna.

The user computing device 102 may then cause a graphical recipe interface to be presented on a display that presents the selected recipe. In some embodiments, the graphical recipe interface may present one or more instructions. For example, the graphical recipe interface may present an instruction to place a container on an appliance (e.g., a kitchen scale), and then place a portion of the food or drink corresponding to the selected recipe on the appliance.

At 806, appliance 106 receives first sensor information corresponding to a container. In some embodiments, appliance 106 may be a kitchen scale having a sensor configured to detect a mass of the container placed upon the scale.

At 808, appliance 106 receives second sensor information corresponding to serving of food being added to the container. In some embodiments, appliance 106 may be a kitchen scale having a sensor configured to detect a change in mass of the container placed upon the scale when the food or drink corresponding to the selected recipe is added to the container. The food and drink item may have been previously made by a user, and verified by a POC application.

At 810, appliance 106 transmits serving information associated with the serving of food to the user computing device 102. For example, based on the first sensor information and the second sensor information appliance 106 may determine a mass of food or drink added to the scale, and transmit the portion of data to the user computing device 102. Alternatively, transmitting the serving information may include the appliance 106 transmitting all sensor data to the user computing device 102. The serving information may be transmitted from appliance 106 to user computing device 102 via a wired or wireless connection. In some embodiments, where the user computing device 102 is integrated into appliance 106, the serving information may be passed between one or more sensors of the appliance and a point of consumption application executing on the user computing device 102 via one or more internal connections.

At 812, user computing device 102 receives the serving information from the appliance 106. For example, where appliance 106 is a kitchen scale and a food or drink is added to a container placed upon the kitchen scale, appliance 106 may transmit serving information corresponding to one or more of the change of mass, an initial mass, a final mass, timing information for a pour event, etc.

At 814, user computing device 102 generates and stores consumption data for the serving. In some embodiments, the user computing device 102 may access recipe data and/or consumption data for the selected food or drink, and may determine consumption data for the serving based on the recipe data/consumption data and the serving information. For example, where the selected recipe is a lasagna that was previously made using a POC application that verified the ingredients used to make the lasagna, the user computing device 102 may access consumption data generated by the POC application that describes the nutritional information for the lasagna. The user computing device 102 may then determine consumption data for the serving that corresponds to the actual amount of ingredients within the food or drink that the user will actually consume. In some embodiments, the consumption data may identify the ingredients in the serving, an amount of the serving, nutritional information for the serving, etc.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. An electronic recipe device comprising:
one or more processing units; and
memory storing computer-executable instructions executable by the one or more processors to perform operations comprising;
presenting a recipe on a display of the recipe device;
presenting an expected ingredient of the recipe;
receiving, from an appliance, verification information comprising sensor data received by the appliance;
determining that the sensor data corresponds to expected sensor data for the expected ingredient;
verifying, based on the sensor data corresponding to the expected sensor data, that the expected ingredient has been added, and
generating, based on the sensor data, verified consumption data for the ingredient.

2. The electronic recipe device as recited in claim 1, wherein determining that the sensor data corresponds to expected sensor data for the expected ingredient comprises determining that the sensor data is within a threshold range of similarity of the expected sensor data for the expected ingredient.

3. The electronic recipe device as recited in claim 1, wherein the appliance is an electronic scale, and the sensor data comprises a first detected mass when an initiation of a pour event is detected and a second detected mass when an end of the pour event is detected.

4. The electronic recipe device as recited in claim 1, wherein the expected ingredient is a first expected ingredient, the verification information comprising sensor data is first verification information comprising first sensor data, the expected sensor data is first expected sensor data, the verified consumption data is first verified consumption data, and the operations further comprise:
presenting a second expected ingredient of the recipe;
receiving, from an appliance, second verification information comprising second sensor data received by the appliance;
determining that the second sensor data corresponds to second expected sensor data for the second expected ingredient; and
generating, based on the second sensor data, second verified consumption data for the second ingredient.

5. The electronic recipe device as recited in claim 4, wherein generating the verified consumption data comprises generating nutritional information for the recipe based on the sensor data.

6. The electronic recipe device as recited in claim 4, wherein the operations further comprise:
determining that a threshold number of ingredients have been added to the recipe;
determining, based on the threshold number of ingredients having been added, that the recipe has been completed; and
generating verified consumption data for the recipe.

7. A computer-implemented method comprising:
presenting, on a display of an electronic recipe device, an expected ingredient of a recipe;
receiving, by the electronic recipe device and from an appliance, verification information comprising sensor data received by the appliance;
determining that the sensor data corresponds to expected sensor data for the expected ingredient; and
generating, based on the verification information, verified consumption data for the ingredient.

8. The computer-implemented method of claim 7, further comprising:
accessing recipe data associated with the recipe, the recipe data comprising at least characteristics of the expected ingredient and a quantity of the ingredient associated with the recipe; and
determining the expected sensor data based on the characteristics of the expected ingredient and the quantity.

9. The computer-implemented method of claim 7, wherein determining that the sensor data corresponds to expected sensor data for the expected ingredient comprises determining that the sensor data is within a threshold range of similarity of the expected sensor data for the expected ingredient.

10. The computer-implemented method of claim 7, further comprising:
receiving, by the electronic recipe device, brand identification information; and
wherein generating the verified consumption data is further based on the brand identification information.

11. The computer-implemented method of claim 7, wherein the expected ingredient is a first expected ingredient, the verification information comprising sensor data is first verification information comprising first sensor data, the expected sensor data is first expected sensor data, and the method further comprises:
presenting a second expected ingredient of the recipe;
receiving, by the electronic recipe device and from the appliance, second verification information comprising second sensor data received by the appliance;
determine that the second sensor data does not match second expected sensor data for the second expected ingredient.

12. The computer-implemented method of claim 11, wherein the verified consumption data is first verified consumption data, and the method further comprises:
determining third expected data for a third ingredient of the recipe;
determining that the second sensor data corresponds to the third expected data;
generating, based on the second sensor data, verified consumption data for the third ingredient.

13. The computer-implemented method of claim 11, further comprising:
presenting, on the display and based on the second sensor data not matching the second expected sensor data, a graphical user interface comprising one or more selectable elements, wherein the selectable elements correspond to suggested ingredients that the user may have added;
receiving input corresponding to one or more third ingredients; and
generating, based on the second sensor data and the input, verified consumption data for the one or more third ingredients.

14. The computer-implemented method of claim 13, wherein the input comprises a voice command identifying the one or more third ingredients.

15. A non-transitory computer-readable storage medium having thereon at set of instructions, which if performed by a computer, cause the computer to at least:
present, on a display of an electronic recipe device, an expected ingredient of a recipe;
receive, by the electronic recipe device and from an appliance, verification information comprising sensor data received by the appliance;
determine that the sensor data corresponds to expected sensor data for the expected ingredient; and
generate, based on the sensor data, verified consumption data for the ingredient.

16. The computing system as recited in claim 15, wherein the appliance is an electronic cooking scale, and the sensor data corresponds to change of mass detected by the electronic cooking scale.

17. The computing system as recited in claim 15, wherein verified consumption data is first verified consumption data, and the instructions further cause the computer to:
receive second verification information comprising an indication that an action has occurred;
determine that the action is associated with a completion of the recipe;
determine, based on at least the first verification data and the action, second verified consumption information for the recipe.

18. The computing system as recited in claim 15, wherein the second verification information comprising the indication that the action has occurred comprises at least one of:
an indication that a blender has been turned on;
an indication that an oven has been preheated;
an indication of commands input to a slow cooker, the oven, or a microwave oven;
an indication that a refrigerator or cabinet has detected that an ingredient has been removed and/or replaced with a reduced quantity; and
an indication that a thermometer has detected a goal temperature.

19. The computer readable media recited in claim 15, wherein the instructions further cause the computer to:
present, on the display and based on receiving the verification data, a graphical user interface comprising one or more selectable elements, wherein the selectable elements correspond to brand information that may be associated with the expected ingredient;
receive input corresponding to a brand of the expected ingredient that was added to the recipe; and
generate, based on the second sensor data and the input, verified consumption data for the second ingredient.

20. The computing system as recited in claim 19, wherein the input comprises a voice command identifying the brand of the expected ingredient that was added to the recipe.
